(19) United States
(12) Patent Application Publication
(10) Pub. No.: US 2014/0262422 A1
(43) Pub. Date: Sep. 18, 2014

(54) LOW STATIC DISCHARGE LAN TWISTED PAIR CABLE

(71) Applicant: CommScope, Inc. of North Carolina, Hickory, NC (US)

(72) Inventors: Robert A. WESSELS, JR., Hickory, NC (US); Joseph J. LICHTENWALNER, Newton, NC (US)

(73) Assignee: CommScope, Inc. of North Carolina, Hickory, NC (US)

(21) Appl. No.: 14/207,425

(22) Filed: Mar. 12, 2014

Related U.S. Application Data
(60) Provisional application No. 61/793,318, filed on Mar. 15, 2013.

(51) Int. Cl. H01B 11/06

(52) U.S. Cl. CPC H01B 11/06
USPC 174/102 R; 174/113 R

(57) ABSTRACT

A cable includes a jacket surrounding a cable core. The cable core includes four twisted pairs. One or more separators may optionally be disposed amongst the twisted pairs. The cable may optionally include a nonconductive core wrap, and/or the cable may optionally include an outer conductive shielding layer wrap. One of more of the twisted pairs, the core wrap, the shielding layer wrap, the separator or the jacket includes an antistatic additive, in the form of a coating or material ingredient.

This application claims the benefit of U.S. Provisional Application No. 61/793,318, filed Mar. 15, 2013, which is herein incorporated by reference.

### BACKGROUND OF THE INVENTION

1. Field of the Invention

The present invention relates to a twisted pair cable for communication of high speed signals, such as a local area network (LAN) cable. More particularly, the present invention relates to a twisted pair cable having an additive to reduce static electrical discharge within the cable.

2. Description of the Related Art

Along with the greatly increased use of computers for homes and offices, there has developed a need for a twisted pair cable, which may be used to connect peripheral equipment to computers and to connect plural computers and peripheral equipment into a common network. Today's computers and peripherals operate at ever increasing data transmission rates. Therefore, there is a continuing need to develop a cable, which can operate substantially error-free at higher bit rates.

Recently it has been discovered that data errors are occurring within twisted pair cables under rather unpredictable circumstances. The data errors seem to be caused by impulse noise of large amplitude, e.g., spikes sometimes exceeding 120 mVolts, on one wire of one twisted pair, or on wires of several twisted pairs. See the Report entitled “Measurements of Self-Generated Noise in F/UTP Cable” dated Feb. 5, 2013 by John Creigh of Broadcom Corporation, which is herein incorporated by reference.

### SUMMARY OF THE INVENTION

Applicants have also studied data errors on twisted pairs and observed the same rather unpredictable circumstances as noted in the Broadcom Corporation Report. One method Applicants used to test a twisted pair cable included monitoring all conductors of the cable and then bending and flexing the cable to different degrees. The bends and flexes seemed to induce the voltage spikes and data errors, as the cable was being bent/flexed and for a brief period after the bending and flexing stopped.

Applicants have constructed and tested modifications to the twisted pair cables which in some instances eliminate, or at the least substantially reduce, the data errors which occur during, and for a period of time after, bending, flexing and/or moving a cable.

Applicants have invented a twisted pair cable with new structural features, the object of which is to enhance one or more performance characteristics of a LAN cable, such as reducing data errors due to static electrical discharge within the cable.

These and other objects are accomplished by a cable that includes a jacket surrounding a cable core. The cable core includes four twisted pairs. One or more separators may optionally be disposed amongst the twisted pairs. The cable may optionally include a nonconductive core wrap, and/or the cable may optionally include an outer conductive shielding layer wrap. One of more of the twisted pairs, the core wrap, the shielding layer wrap, or the jacket includes an antistatic additive, in the form of a coating or material ingredient.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of a shielded, twisted pair cable, in accordance with a first embodiment of the present invention;

FIG. 2 is a cross sectional view taken along line II-II in FIG. 1;

FIG. 3 is a cross sectional view of a shielding layer in FIGS. 1 and 2;

FIG. 4 is a perspective view of a twisted pair cable, in accordance with a second embodiment of the present invention;

FIG. 5 is a cross sectional view taken along line V-V in FIG. 4;

FIG. 6 is a perspective view of a twisted pair cable, in accordance with a third embodiment of the present invention; and

FIG. 7 is a perspective view of a twisted pair cable, in accordance with a fourth embodiment of the present invention.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

FIGS. 1 and 2 show a shielded twisted pair cable 1, in accordance with a first embodiment of the present invention. The twisted pair cable 1 has four twisted wire pairs (a first twisted pair A, a second twisted pair B, a third twisted pair C and a fourth twisted pair D). A dielectric separator 3, such as the illustrated tape, separates twisted pairs A and C from twisted pairs B and D. The twisted pairs A, B, C and D in combination with the separator 3 may be twisted in the direction of arrow 5 (e.g., opposite to the twist direction of the twisted pairs A, B, C and D) to form a stranded core. The stranded core is wrapped or surrounded by a wrap having conductive properties, e.g., a shielding layer 7. The shielding layer 7 may be formed of a conductive foil, and the foil's edges may partially overlap at area 9. A dielectric jacket 11 surrounds the shielding layer 7.

Each twisted pair A, B, C and D includes two insulated conductors. Specifically, the first twisted pair A includes a first insulated conductor 13 and a second insulated conductor 15. The second twisted pair B includes a third insulated conductor 17 and a fourth insulated conductor 19. The third twisted pair C includes a fifth insulated conductor 21 and a sixth insulated conductor 23. The fourth twisted pair D includes a seventh insulated conductor 25 and an eighth insulated conductor 27.

Each twisted pair A, B, C and D is formed by having its two insulated conductors continuously twisted around each other. For the first twisted pair A, the first conductor 13 and the second conductor 15 twist completely about each other, three hundred sixty degrees (illustrated by dashed line a), at a first interval w along the length of the cable 1. For the second twisted pair B, the third conductor 17 and the fourth conductor 19 twist completely about each other, three hundred sixty degrees (illustrated by dashed line b), at a second interval x along the length of the cable 1. For the third twisted pair C, the fifth conductor 21 and the sixth conductor 23 twist completely about each other, three hundred sixty degrees (illustrated by dashed line c), at a third interval y along the length of the cable 1. For the fourth twisted pair D, the seventh conductor 25 and the eighth conductor 27 twist completely about each other, three hundred sixty degrees (illustrated by dashed line d), at a fourth interval z along the length of the cable 1.

Each of the twisted pairs A, B, C and D has a fixed twist interval w, x, y, z, respectively. Each of the twist intervals w, x, y, z is different from the twist interval of the other twisted pairs. As is known in the art, such an arrangement assists in reducing crosstalk between the twisted pairs within the cable 1, which is referred to as internal crosstalk. In one embodiment of the prior art, each of the twisted pairs A, B, C and D has a unique fixed twist interval of slightly more than, or less than, 0.500 inches. Table 1 below summarizes the twist interval ranges for the twisted pairs A, B, C and D.

TABLE 1

| | | Min. | Max |
|---|---|---|---|
| Twisted | | Twist | Twist |
| Pair | Twist Length | Length | Length |
| A | 0.440 | 0.430 | 0.450 |
| B | 0.410 | 0.400 | 0.420 |
| C | 0.596 | 0.580 | 0.610 |
| D | 0.670 | 0.650 | 0.690 |

In order to prevent a static electric discharge within the cable during and after cable movement, which may result in a data transmission error, the cable 1, as described above and depicted in FIGS. 1 and 2, has an antistatic additive applied to at least one of the first, second, third or fourth twisted pairs A, B, C or D, the separator 3 or the wrap, e.g., the shielding layer 7. “Applied” means applied on an outer surface as a coating or impregnating layer, e.g., as a sprayed on exterior layer, and also means applied as an ingredient to the actual member, e.g., an additive to a slurry mix that is extruded into a polymer component.

One particularly suitable antistatic additive is a product called Staticide® by ACL, Inc. of Chicago, Ill. Staticide is a water-based formulation compatible with the materials used in the components of the cable 1, as further noted below. Another particularly suitable antistatic additive is included in a sheet material made by NEPTCO, INC. of Pawtucket, R.I.

In a one embodiment, the antistatic additive is a sprayed-on coating 30 applied only on the shielding layer 7. Applying the antistatic additive as a coating on the first, second, third and fourth twisted pairs A, B, C and D can be messy and problematic during manufacturing. Also, test results have shown that applying the antistatic additive as a spray-on coating to only the shielding layer 7 was effective in eliminating data errors caused by voltage spikes within the cable core during and after movement of the cable 1. The coating layer may be applied to only the inside surface of the shielding layer 7 or to both surfaces of the shielding layer 7 to enable more expedient manufacturing.

In an alternative embodiment, the antistatic additive may be applied as a coating to the first, second, third and fourth twisted pairs A, B, C and D, and not to the shielding layer 7. Test results have shown that applying the antistatic additive as a spray on coating to only the first, second, third and fourth twisted pairs A, B, C and D was effective in eliminating data errors caused by voltage spikes within the cable core during and after movement of the cable 1.

The separator 3 may also be coated with the antistatic additive. Although FIGS. 1 and 2 have depicted the separator 3 as a flat tape, the separator 3 may have other shapes, such as an S-shaped, a plus-shaped or star-shaped separator. Further, all internal components of the cable 1 may be coated with the antistatic additive, although test results have not shown this to be a necessary step to prevent the data errors caused by internal voltage spikes.

In another preferred embodiment, the antistatic additive is an ingredient of a material forming the shielding layer 7. In one embodiment, the shielding layer 7 is a two layer structure (See FIG. 3). A first layer 32 is formed of a conductive material, like a metal foil. A second layer 34, adhered to the first layer 32, is formed of a nonconductive material, like a polymer or polyester film, like biaxially-oriented polyethylene terephthalate, e.g., Mylar®. The antistatic additive may be an ingredient used in the formation of the second layer 34. Preferably, the second layer 34 faces to the cable core. Further, the antistatic additive may be an ingredient used in the formation of the separator 3 or in the formation of the insulating layer of one or more of the insulated conductors 13, 15, 17, 19, 21, 23, 25 or 27.

The separator 3 may be formed of at least two layers, with one layer being conductive and another layer being nonconductive, similar to FIG. 3. The nonconductive layer of the separator may be coated with the antistatic additive, or the antistatic additive may be an ingredient used to manufacture the nonconductive layer of the separator 3.

FIGS. 4 and 5 show a twisted pair cable 41, in accordance with a second embodiment of the present invention. The same elements from the above embodiments have been labeled with the same reference numerals.

In the second embodiment, the wrap is no longer a conductive shielding layer 7. Instead, the wrap is now formed of a nonconductive core wrap 35. The nonconductive core wrap 35 may be formed of a polymer, polyester (like Mylar®), paper, or similar material. The nonconductive core wrap 35 may be overlapped as shown at area 37 and may optionally be adhered to itself in the area 37. The separator 3 has also been optionally removed from the cable core. All other aspects of the second embodiment of the cable 41 are the same as the first embodiment of the cable 1.

In a preferred embodiment, antistatic additive is applied to said nonconductive core wrap 35 as a coating 30. Alternatively, the antistatic additive is an ingredient of a material forming the core wrap 35.

FIG. 6 shows a shielded twisted pair cable 51, in accordance with a third embodiment of the present invention. The same elements from the above embodiments have been labeled with the same reference numerals.

In the third embodiment, the nonconductive core wrap 35 is still employed and the conductive shielding layer 7 has been added and surrounds the nonconductive core wrap 35. FIG. 6 shows the separator 3 in the cable core, however the separator 3 may optionally be removed. In a preferred embodiment, the antistatic additive is applied to the nonconductive core wrap 35 as a coating 30. Alternatively or additionally, in another preferred embodiment, the antistatic additive is an ingredient of a material forming the core wrap 35.

FIG. 7 shows a twisted pair cable 61, in accordance with a fourth embodiment of the present invention. The same elements from the above embodiments have been labeled with the same reference numerals.

In the fourth embodiment, the nonconductive core wrap 35, the conductive shielding layer 7 and the separator 3 have all been removed. The antistatic additive may be a coating 30 on the inside of the jacket 11 and/or a coating on the first, second, third and fourth twisted pairs A, B, C and D. The antistatic additive may be an ingredient used in the formation of the jacket 11. Further, the antistatic additive may be an ingredient used in the formation of the insulating layer of one or more of the insulated conductors 13, 15, 17, 19, 21, 23, 25 or 27.

The performance in the above described embodiments could additionally be enhanced by employing a striated jacket 11, as shown in U.S. Pat. No. 5,796,046 and published U.S. Application 2005/0133246, both of which are herein incorporated by reference. The performance could be further enhanced by employing twist modulation and/or core strand modulation, as shown in the Assignee's U.S. Pat. No. 6,875,928, which is incorporated herein by reference.

Such variations are not to be regarded as a departure from the spirit and scope of the invention, and all such modifications as would be obvious to one skilled in the art are to be included within the scope of the following claims.

We claim:

1. A cable comprising:
a first twisted pair;
a second twisted pair;
a third twisted pair;
a fourth twisted pair;
a wrap disposed around said first, second, third and fourth twisted pairs;
a jacket surrounding said wrap; and
an antistatic additive applied to at least one of said first, second, third or fourth twisted pairs or to said wrap.

2. The cable according to claim 1, wherein said antistatic additive is a coating on said wrap and is not applied to said first, second, third or fourth twisted pairs.

3. The cable according to claim 1, wherein said antistatic additive is a coating on at least one of said first, second, third or fourth twisted pairs and is not applied to said wrap.

4. The cable according to claim 1, wherein said wrap is a nonconductive core wrap, and wherein said antistatic additive is applied to said nonconductive core wrap.

5. The cable according to claim 4, further comprising:
a conductive shielding layer surrounding said nonconductive core wrap.

6. The cable according to claim 1, wherein said wrap has conductive properties and constitutes a conductive shielding layer, and wherein said antistatic additive is applied to said conductive shielding layer.

7. The cable according to claim 1, wherein said antistatic additive is an ingredient of a material forming said wrap.

8. The cable according to claim 1, wherein said wrap includes at least two layers, with a first layer being a conductive foil and a second layer being a nonconductive material having said antistatic additive applied thereto.

9. The cable according to claim 1, wherein said antistatic additive is an ingredient of an insulating material forming an insulation layer of one or both insulated conductors used in forming at least one of said first, second, third and fourth twisted pairs.

10. A cable comprising:
a first twisted pair;
a second twisted pair;
a third twisted pair;
a fourth twisted pair;
a jacket surrounding said first, second, third and fourth twisted pairs;
a separator disposed within jacket separating said first twisted pair from at least one of said second, third and fourth twisted pairs; and
an antistatic additive applied to at least one of said first, second, third or fourth twisted pairs or to said separator.

11. The cable according to claim 10, wherein said antistatic additive is a coating on said separator and is not applied to said first, second, third or fourth twisted pairs.

12. The cable according to claim 10, wherein said antistatic additive is a coating on all of said first, second, third or fourth twisted pairs and said separator.

13. The cable according to claim 10, further comprising:
a nonconductive core wrap surrounding said first, second, third or fourth twisted pairs.

14. The cable according to claim 10, further comprising:
a conductive shielding layer surrounding said first, second, third or fourth twisted pairs.

15. The cable according to claim 10, wherein said antistatic additive is an ingredient of a material forming said separator.

16. The cable according to claim 10, wherein said separator includes at least two layers, with a first layer being a conductive foil and a second layer being a nonconductive material having said antistatic additive applied thereto.

17. The cable according to claim 10, wherein said antistatic additive is an ingredient of an insulating material forming an insulation layer of one or both insulated conductors used in forming at least one of said first, second, third and fourth twisted pairs.

18. A cable comprising:
a first twisted pair;
a second twisted pair;
a third twisted pair;
a fourth twisted pair;
a jacket surrounding said first, second, third and fourth twisted pairs; and
an antistatic additive applied to at least one of said first, second, third or fourth twisted pairs or to an inside of said jacket.

19. The cable according to claim 18, wherein said antistatic additive is a coating on said inside of said jacket.

20. The cable according to claim 18, wherein said antistatic additive is an ingredient of an insulating material forming an insulation layer of one or both insulated conductors used in forming at least one of said first, second, third and fourth twisted pairs or forming said jacket.
